(19) United States
(12) Patent Application Publication
(10) Pub. No.: US 2025/0037903 A1
(43) Pub. Date: Jan. 30, 2025

(54) MULTI-CORE CABLE

(71) Applicant: SUMITOMO ELECTRIC INDUSTRIES, LTD., Osaka (JP)

(72) Inventor: Seiji TANAKA, Tochigi (JP)

(73) Assignee: SUMITOMO ELECTRIC INDUSTRIES, LTD., Osaka (JP)

(21) Appl. No.: 18/785,560

(22) Filed: Jul. 26, 2024

(30) Foreign Application Priority Data
Jul. 28, 2023 (JP) 2023-123611

(51) Int. Cl. H01B 7/22; H01B 11/18

(52) U.S. Cl. CPC H01B 7/228; H01B 11/1878

(57) ABSTRACT

A multi-core cable includes a plurality of cable units, a shield layer that covers the plurality of cable units, and a first sheath. The plurality of cable units are bundled. An outer diameter of the first sheath is 10 mm or less. The cable unit includes a plurality of core electric wires. The core electric wire includes a coaxial wire. The coaxial wire includes a center conductor, an insulating layer that covers the center conductor, an outer conductor that covers the insulating layer, and a second sheath that covers the outer conductor. A diameter of the center conductor is 0.09 mm or less. The shield layer is formed of a metallic braid where metal wires are braided. A braid angle of the metallic braid is 60 degrees or more and 64 degrees or less.

### CROSS-REFERENCE TO RELATED APPLICATION

This application claims priority from Japanese Patent Application No. 2023-123611, filed on Jul. 28, 2023, the entire subject matter of which is incorporated herein by reference.

### TECHNICAL FIELD

The present disclosure relates to a multi-core cable.

### BACKGROUND

JPH10-326525A discloses a cable for movement that includes a shield layer having a braided structure.

### SUMMARY

A multi-core cable is frequently adopted in an environment where it is required to perform bending and twisting multiple times. However, a complicated structure or an expensive material needs to be used for improving bendability and twistability of a multi-core cable in the related art.

An object of the present disclosure is to provide a multi-core cable having high durability with a simple structure.

An embodiment of the present disclosure provides a multi-core cable including:
a plurality of cable units;
a shield layer that covers the plurality of cable units; and
a first sheath,
wherein the plurality of cable units are bundled,
an outer diameter of the first sheath is 10 mm or less,
the cable unit includes a plurality of core electric wires,
the core electric wire includes a coaxial wire,
the coaxial wire includes a center conductor, an insulating layer that covers the center conductor, an outer conductor that covers the insulating layer, and a second sheath that covers the outer conductor,
a diameter of the center conductor is 0.09 mm or less,
the shield layer is formed of a metallic braid where metal wires are braided, and
a braid angle of the metallic braid is 60 degrees or more and 64 degrees or less.

According to the above description, the durability of the multi-core cable can be improved with a simple structure.

### BRIEF DESCRIPTION OF DRAWINGS

FIG. 1 is a schematic cross-sectional view illustrating an example of a cable with a connector according to the present disclosure.

FIG. 2 is an enlarged view illustrating an end portion of the cable illustrated in FIG. 1.

FIG. 3 is a side view illustrating a metallic braid of the cable illustrated in FIG. 2.

FIG. 4A is a side view illustrating the metallic braid of the cable according to the present disclosure.

FIG. 4B is a side view illustrating a metallic braid of a cable according to Comparative Example.

FIG. 5 is a schematic diagram illustrating a bend test that is performed on the cable according to the present disclosure.

FIG. 6 is a schematic diagram illustrating a twist test that is performed on the cable according to the present disclosure.

### DESCRIPTION OF EMBODIMENTS

### Description of Embodiment of Present Disclosure

First, embodiments of the present disclosure will be described.

(1) A multi-core cable according to one aspect of the present disclosure includes:

a plurality of cable units; a shield layer that covers the plurality of cable units; and a first sheath, in which the plurality of cable units are bundled, an outer diameter of the first sheath is 10 mm or less, the cable unit includes a plurality of core electric wires, the core electric wire includes a coaxial wire, the coaxial wire includes a center conductor, an insulating layer that covers the center conductor, an outer conductor that covers the insulating layer, and a second sheath that covers the outer conductor, a diameter of the center conductor is 0.09 mm or less, the shield layer is formed of a metallic braid where metal wires are braided, and a braid angle of the metallic braid is 60 degrees or more and 64 degrees or less.

With this configuration, by adjusting the braid angle of the metallic braid (shield layer) that covers the cable unit, the durability of the multi-core cable can be easily improved.

(2) In the multi-core cable according to (1), a braid density of the metallic braid may be 97% or higher.

(3) In the multi-core cable according to (1), the metallic braid of the shield layer may be formed of a non-plated tin-copper alloy wire.

(4) In the multi-core cable according to (1), a diameter of a wire used in the metallic braid may be 0.04 mm or more and 0.10 mm or less.

(5) In the multi-core cable according to (1), an inner diameter of the shield layer may be 7.2 mm or more and 7.8 mm or less.

(6) In the multi-core cable according to (1), a tape layer may be provided between the plurality of cable units and the shield layer, the plurality of cable units may be bundled by the tape layer, and a void may be formed between the plurality of cable units.

(7) In the multi-core cable according to (1), the plurality of cable units are bundled by a filament.

With this configuration, by adjusting the braid density of the metallic braid (shield layer) that covers the cable unit, the durability of the multi-core cable can be easily improved.

### Details of Embodiment of Present Disclosure

A specific example of a multi-core cable according to an embodiment of the present disclosure will be described below with reference to the drawings. The present disclosure is not limited to these examples and is intended to include any modifications within the scope and meaning equivalent to the terms of the claims.

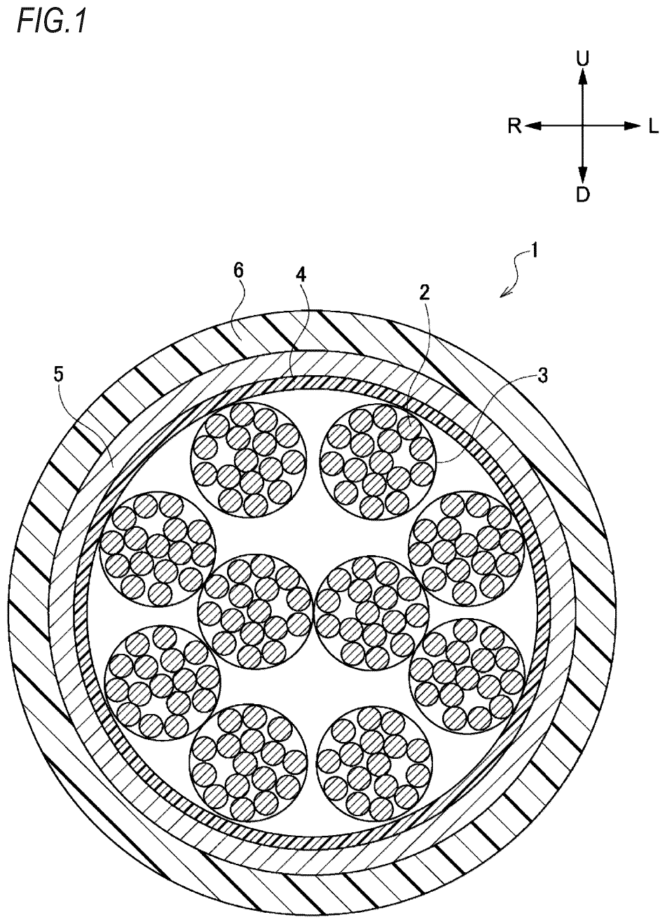

In FIG. 1 and the like, U, D, F, B, R, and L represent directions of a multi-core cable 1, and U represents an up direction, D represents a down direction, F represents a front direction, B represents a back direction, R represents a right direction, and L represents a left direction.

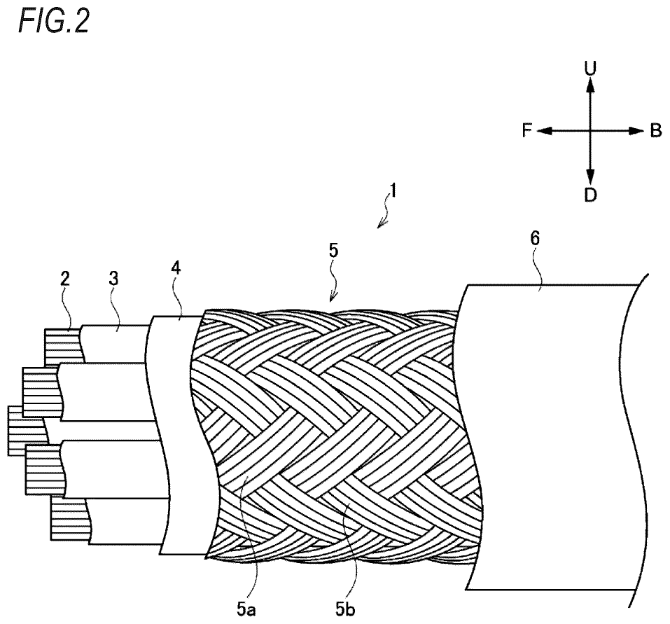

The multi-core cable 1 according to the present disclosure will be described using FIGS. 1 and 2. FIG. 1 is a schematic cross-sectional view illustrating an example of the multi-core cable 1 according to the present disclosure. FIG. 2 is an enlarged view illustrating an end portion of the multi-core cable 1 according to the present disclosure. The multi-core cable 1 according to the present embodiment can be used for, for example, wiring of a medical electronic equipment. As illustrated in FIG. 1, the multi-core cable 1 includes: a plurality of cable units 3; a tape layer 4 where the plurality of cable units 3 are bundled; a shield layer 5 that covers the tape layer 4; and a first sheath 6 that covers the shield layer 5. Each of the plurality of cable units 3 includes a plurality of electric wires 2.

The electric wire according to the present disclosure is not illustrated in the drawing. However, the electric wire 2 includes at least a center conductor. The center conductor is a single wire formed of a conductive metal such as a copper alloy or is a stranded wire where a plurality of thin wires are stranded. The insulating layer is formed of an insulating resin, protects the center conductor, and electrically insulates the center conductor from the surroundings. The multi-core cable 1 according to the present disclosure is assumed to be used in an environment where bending or twisting is performed multiple times. The diameter of the center conductor is desirably 0.048 mm or more and 0.09 mm or less. In addition, at least one of the cable units 3 includes a coaxial wire as the electric wire 2. The coaxial wire includes a center conductor, an insulating layer that covers the center conductor, an outer conductor that covers the insulating layer, and a second sheath that covers the outer conductor.

The cable unit 3 according to the present disclosure is configured by bundling a plurality of the electric wires 2. For example, the electric wires 2 may be bundled by a tape or may be fixed by a resin or the like. In the multi-core cable 1 according to the present embodiment, one cable unit 3 includes 16 electric wires 2.

As illustrated in FIG. 1, in the multi-core cable 1 according to the present disclosure, the plurality of cable units 3 are bundled by the tape layer 4. The tape layer 4 is formed of, for example, polyethylene terephthalate. In addition, from the viewpoint of the bendability of the multi-core cable 1, the thickness of the tape layer is preferably 5 μm or more and 30 μm or less. In the multi-core cable according to the present embodiment, the cable units 3 are bundled by the tape layer 4. Therefore, a void is formed between the plurality of cable units 3. The use of the tape layer 4 is not essential. For example, a filament such as a resin can be wound instead of using the tape. The multi-core cable 1 according to the present embodiment is configured by bundling 10 cable units 3 using the tape layer 4.

The tape layer 4 is further covered with the shield layer 5. The shield layer 5 according to the present disclosure is formed by a metallic braid as illustrated in FIG. 2, and inhibits leakage of noise or inhibits noise from being mixed in a signal transmitted through the center conductor. In addition, since the shield layer 5 is formed of a metallic braid, the flexibility of the multi-core cable 1 can be improved. In the present embodiment, the metallic braid of the shield layer 5 is formed of a non-plated tin-copper alloy wire (tin content: 0.3 mass %), and the diameter of a wire used in the metallic braid is 0.04 mm or more and 0.10 mm or less. From the viewpoint of bendability, the inner diameter of the shield layer 5 is preferably 7.2 mm or more and 7.8 mm or less. The metallic braid of the shield layer 5 is configured by braiding a first braid 5a that extends in a direction intersecting with an axial direction of the multi-core cable 1 and a second braid 5b that extends in a direction intersecting with the axial direction of the multi-core cable 1 and the direction in which the first braid 5a extends. From the viewpoint of shielding noise from the outside, the braid density of the metallic braid is 97% or higher.

The shield layer 5 is further covered with the first sheath 6. The first sheath 6 is formed of an insulating resin, electrically insulates the shield layer 5 from the outside, and inhibits damages of the shield layer 5. The first sheath 6 is formed of, for example, polyvinyl chloride (PVC) or a thermoplastic elastomer (TPE), in particular, a polyolefin-based thermoplastic elastomer (TPO). From the viewpoint of an environment where the multi-core cable 1 according to the present disclosure is used, the outer diameter of the first sheath 6 is 10 mm or less.

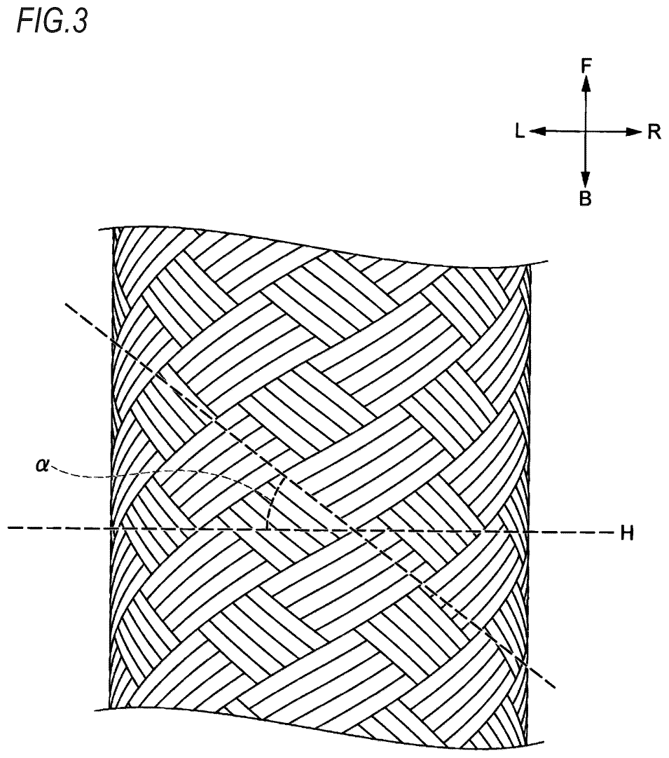

Next, the shield layer 5 of the multi-core cable 1 according to the present disclosure will be described in detail using FIG. 3. FIG. 3 is a side view schematically illustrating the metallic braid of the cable illustrated in FIG. 2. In FIG. 3, the F direction and the B direction are the axial direction of the multi-core cable 1. As illustrated in FIG. 3, the metallic braid is braided such that the first braid 5a and the second braid 5b intersect with each other at a certain angle. In FIG. 3, an angle α at which the first braid 5a or the second braid 5b intersects with a virtual line H where the first braid 5a and the second braid 5b are orthogonal to the cable axial direction will be referred to as the braid angle α. In the multi-core cable 1 according to the present disclosure, the braid angle α is 60 degrees or more and 64 degrees or less. By setting the braid angle α to be 60 degrees or more and 64 degrees or less, the durability of the multi-core cable 1 can be improved.

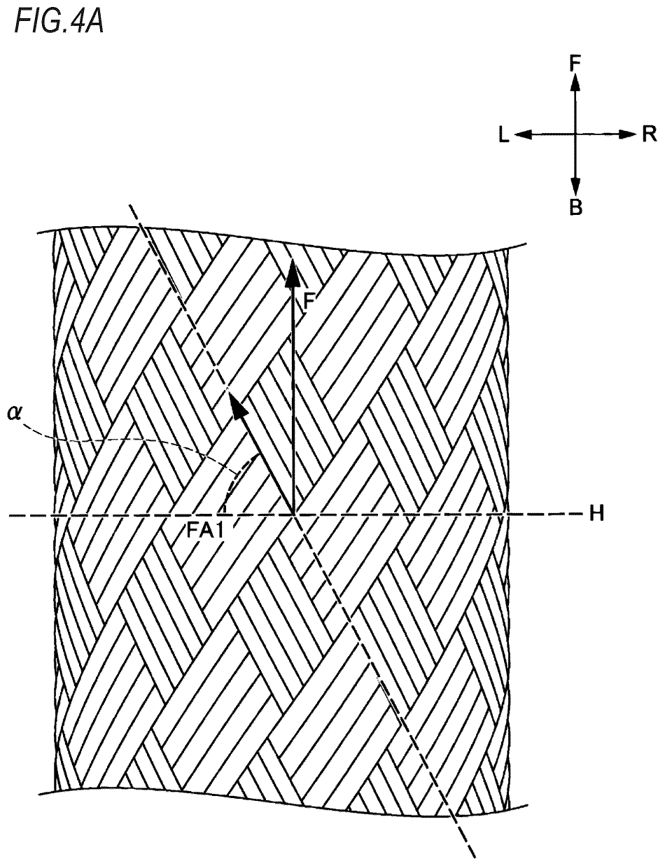

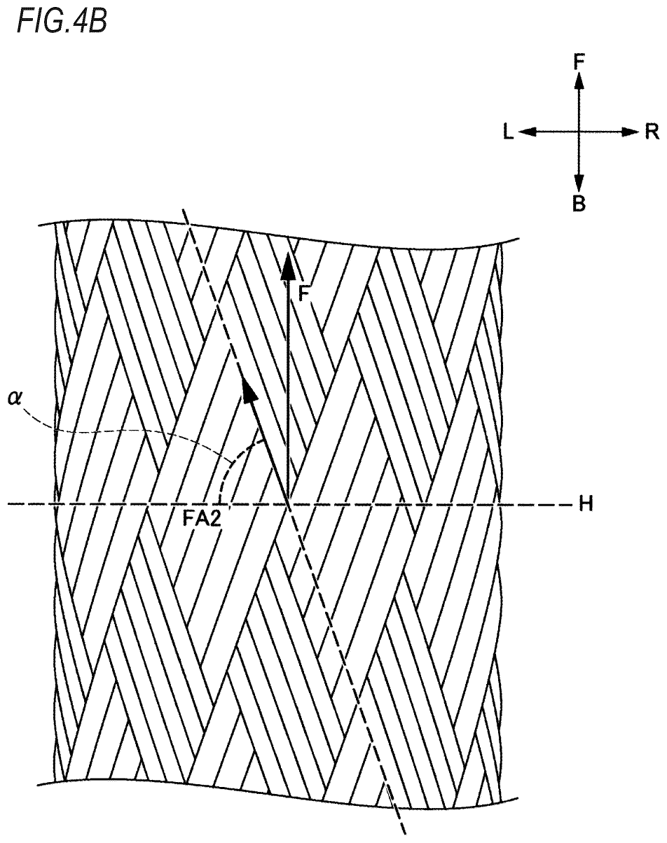

Next, a relationship between the braid angle α and the durability of the multi-core cable 1 will be described in detail using FIGS. 4A and 4B. FIG. 4A is a side view illustrating the metallic braid of the multi-core cable according to the present disclosure. FIG. 4B is a side view illustrating a metallic braid of a multi-core cable 1 according to Comparative Example. In addition, when a bending force F is applied to each of the multi-core cables in the axial direction of the multi-core cable 1, an arrow indicating a way of applying the force is illustrated in each of FIGS. 4A and 4B.

In the multi-core cable 1 (FIG. 4A) according to the present disclosure, the braid angle α is 60 degrees or more and 64 degrees or less. On the other hand, in the multi-core cable 1 (FIG. 4B) according to Comparative Example, the braid angle α is larger than 64 degrees. As illustrated in FIG. 4A, the braid angle α of the multi-core cable 1 according to the present disclosure is larger than that of Comparative Example. Therefore, when the multi-core cable 1 is bent and the bending force F is applied along an elongation direction in an outer portion or an inner portion of bending, a bending force FA1 relating to a direction parallel to the metallic braid is lower than a bending force FA2 relating to a direction parallel to the metallic braid according to Comparative Example. That is, in the multi-core cable 1 according to the present disclosure, a strain relating to the metallic braid (elongation strain in a length direction in the wire of the metallic braid) can be suppressed.

When the braid angle α is less than 60 degrees, the number of times the metallic braid is wound increases significantly. Therefore, the method of manufacturing the multi-core cable significantly increases. In addition, the thickness of the shield layer 5 increases, and the diameter of the multi-core cable 1 increases.

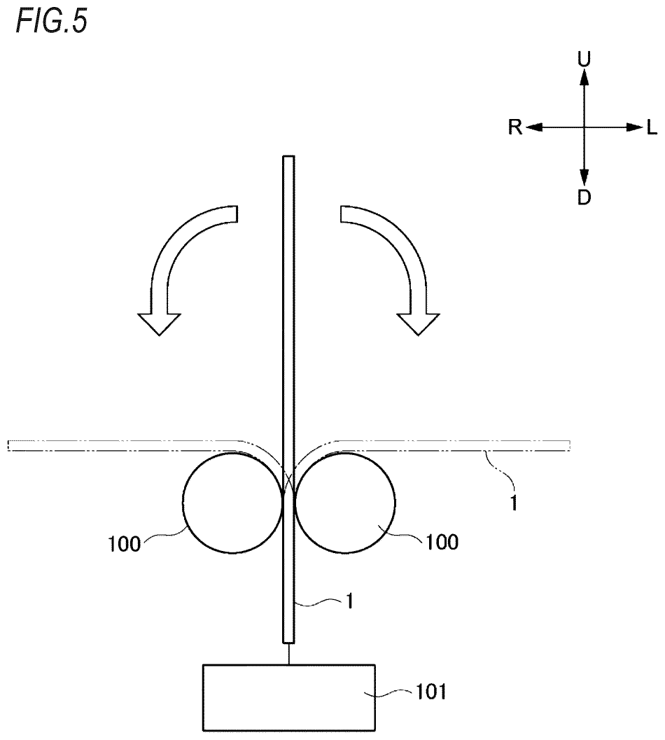

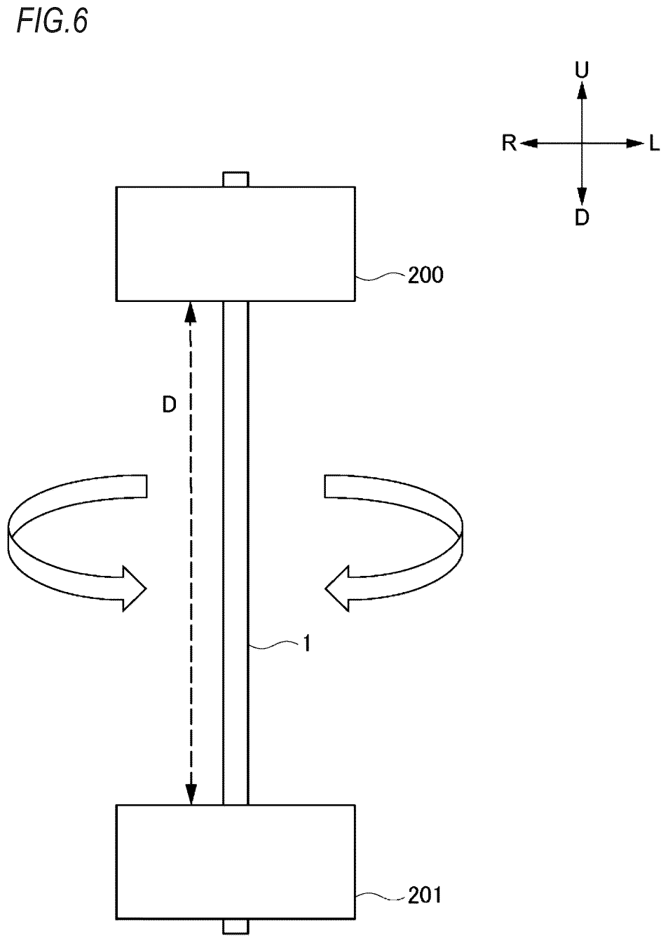

In order to measure the durability of the multi-core cable 1 according to the present disclosure, two kinds of multi-core cables according to Example 1 and Comparative Example 1 were trial-manufactured, and a bend test and a twist test were performed. In the multi-core cable according to Example 1, the braid angle α was 62 degrees. In the multi-core cable according to Comparative Example 1, the braid angle α was 66 degrees. Configurations other than the braid angle α were the same. When the braid angle α was 62 degrees, the braid density was about 97%. Test methods will be described in detail using FIGS. 5 and 6. FIG. 5 is a schematic diagram illustrating the test method of the bend test. FIG. 6 is a schematic diagram illustrating the test method of the twist test.

### (Bend Test)

As illustrated in FIG. 5, the bend test was performed by fixing the multi-core cable 1 in a state of being interposed between a pair of mandrels 100 and bending the multi-core cable 1 along the mandrels 100. The multi-core cable 1 was bent along one of the mandrels 100 and returned to the original position. Next, the multi-core cable 1 was bent along the other one of the mandrels 100 and returned to the original position. This operation was set as one cycle (once). After performing 250,000 cycles of the bend test on the multi-core cable 1, a fracture state and an electrical conduction state of the multi-core cable 1 were verified. The bend test was performed in a state where a bending angle of the multi-core cable 1 was +90 degrees, a bending speed was 30 cycles/min, a bending radius (radius of the mandrel) was 30 mm, and a load 101 of 1000 g was applied to an end portion of the multi-core cable 1.

In the results of the bend test, even when the multi-core cable according to Example 1 was repeatedly bent 250,000 times, fracture of the metallic braid did not occur, and conduction of an electrical signal was able to be verified. On the other hand, after the multi-core cable according to Comparative Example 1 was repeatedly bent 150,000 times, the metallic braid was fractured, and conduction of an electrical signal was not able to be verified. It was verified from the above results of the bend test that, by setting the braid angle α to 60 degrees or more and 64 degrees or less, the durability of the multi-core cable 1 against bending can be improved.

### (Twist Test)

As illustrated in FIG. 6, the twist test was performed by fixing one end of the multi-core cable 1 with a fixed end 200, fixing an end portion opposite to the end portion fixed by the fixed end 200 with a hinged end 201, and rotating the hinged end 201 to twist the multi-core cable 1. The hinged end 201 was rotated clockwise by 180 degrees from the initial position when the multi-core cable 1 was seen from a U direction, and returned to the initial position. The hinged end 201 was rotated counterclockwise by 180 degrees and returned to the original position. This operation was set as one cycle (once). After performing 250,000 cycles of the twist test on the multi-core cable 1, a fracture state of the multi-core 1 and an electrical conduction state of the shield layer 5 were verified. The twist test was performed in a state where a distance D from the fixed end 200 to the hinged end 201 was 500 mm and a rotating speed of the hinged end 201 was 30 cycles/min. The test was performed in a state where the weight of the hinged end 201 was 1000 g and a normal load of 1000 g was applied to the multi-core cable 1.

In the results of the twist test, even when the multi-core cable according to Example 1 was repeatedly twisted 250,000 times, fracture of the metallic braid did not occur, and conduction of an electrical signal was able to be verified. On the other hand, after the multi-core cable according to Comparative Example 1 was repeatedly twisted 150,000 times, the metallic braid was fractured, and conduction of an electrical signal was not able to be verified. It was verified from the above results of the twist test that, by setting the braid angle α to 60 degrees or more and 64 degrees or less, the durability of the multi-core cable 1 against twisting can be improved.

The multi-core cable may be adopted in an environment where it is required to perform bending and twisting multiple times. A complicated structure or an expensive material needs to be used for improving bendability and twistability of a multi-core cable in the related art. Therefore, the improvement of the durability of the multi-core cable using a simple method is required.

Accordingly, the present inventors found that, by adjusting the braid angle of the metallic braid (shield layer) covering the cable unit, the durability of the multi-core cable can be easily improved.

In the multi-core cable 1 according to the present disclosure, by setting the braid angle α of the metallic braid to be 60 degrees or more and 64 degrees or less, the multi-core cable 1 having high durability can be provided with a simple structure.

Hereinabove, the embodiment of the present disclosure has been described. However, it is needless to say that the technical range of the present disclosure is not intended to be limited to the description of the present embodiment. The present embodiment is merely exemplary, and it is easily understood by those skilled in the art that various changes can be made for the embodiment within the scope of the invention described in the claims. The technical range of the present disclosure should be determined based on the scope of the invention described in the claims and its equivalent scope.

What is claimed is:

1. A multi-core cable comprising:
a plurality of cable units;
a shield layer that covers the plurality of cable units; and
a first sheath,
wherein the plurality of cable units are bundled,
an outer diameter of the first sheath is 10 mm or less,
the cable unit includes a plurality of core electric wires,
the core electric wire includes a coaxial wire,
the coaxial wire includes a center conductor, an insulating layer that covers the center conductor, an outer conductor that covers the insulating layer, and a second sheath that covers the outer conductor,
a diameter of the center conductor is 0.09 mm or less,
the shield layer is formed of a metallic braid where metal wires are braided, and
a braid angle of the metallic braid is 60 degrees or more and 64 degrees or less.

2. The multi-core cable according to claim 1,
wherein a braid density of the metallic braid is 97% or higher.

3. The multi-core cable according to claim 1,
wherein the metallic braid of the shield layer is formed of a non-plated tin-copper alloy wire.

4. The multi-core cable according to claim 1,
wherein a diameter of a wire used in the metallic braid is 0.04 mm or more and 0.10 mm or less.

5. The multi-core cable according to claim 1,
wherein an inner diameter of the shield layer is 7.2 mm or more and 7.8 mm or less.

6. The multi-core cable according to claim 1,
wherein a tape layer is provided between the plurality of cable units and the shield layer,
wherein the plurality of cable units are bundled by the tape layer, and
wherein a void is formed between the plurality of cable units.

7. The multi-core cable according to claim 1,
wherein the plurality of cable units are bundled by a filament.
